(19) United States
(12) Patent Application Publication
(10) Pub. No.: US 2008/0032240 A1
(43) Pub. Date: Feb. 7, 2008

(54) Reduction of CO2 reaction at developer surface

(76) Inventors: Howard A. Fromson, Stonington, CT (US); William J. Rozell, Vernon, CT (US); William J. Ryan, Enfield, CT (US); Sean P. Evans, Tolland, CT (US)

Correspondence Address: ALIX YALE & RISTAS LLP, 750 MAIN STREET, SUITE 1400, HARTFORD, CT, 06103, US

(21) Appl. No.: 11/499,088

(22) Filed: Aug. 4, 2006

(51) Int. Cl. G03C 5/00

(52) U.S. Cl. 430/327

(57) ABSTRACT

In a system and process for developing an imaged plate by contacting the plate with an alkaline developer, contained in a developer tank having a cover spaced over the developer level, the space between the developer level and cover is maintained at a concentration of carbon dioxide below ambient for a substantial portion of each day. Preferably, active carbon dioxide control is implemented in the space at least during idle periods, to maintain the concentration of carbon dioxide below about 100 ppm, preferably in the range of 0-10 ppm. The system has a first conduit with an extraction port in the space and a second conduit with a return port in the space. A canister of carbon dioxide scavenger material is fluidly connected between the conduits. A motorized air handling device fluidly connected with the conduits and scavenger material, draws air out of the space, passes the drawn air through the canister, and delivers the scavenged air back into the space. A special cover having the ports, can be fit over the developer to enhance the sealing of the space from ambient air and thereby improve efficiency.

### BACKGROUND OF THE INVENTION

The present invention relates to development of images on a coated plate or the like, in which the plate is passed through an alkaline developer bath.

In such a process, a problem is encountered arising from the carbon dioxide in the ambient air. The problem is caused by the absorption of carbon dioxide into the developer through the exposed surface of the bath. When carbon dioxide dissolves in the developer it is converted to carbonic acid. This acid neutralizes the alkaline materials in the developer, and/or has other deleterious effects on the developer or development process. Even over a short period of idle time of the developer station, the effectiveness of the developer bath is lowered to the point where plates will no longer develop to commercially acceptable standards.

In the past there have been a number of different approaches taken to overcome this problem. The typical approaches have been: (1) addition of a buffering agent to the developer to act as a carbon dioxide scavenger; (2) covering the surface of the developer in order to prevent the absorption of carbon dioxide; (3) use of more developer solution as a replenisher to constantly replace and/or freshen the spent developer; and (4) use of small amounts of a strong alkaline solution as a replenisher to replace the neutralized alkaline material in the developer.

Although these approaches did to some extent either reduce or eliminate the problem, they were not without problems of their own. In the case of using a buffering agent or a cover the problem was only delayed for a short period of time. The use of the developer as a replenisher worked well but a large volume was required, causing an increase in the waste streams and a major increase in chemistry costs. Finally, the use of a strong alkaline solution metered into the developer at a very specific rate can work, but it must be monitored very closely to make sure that the developer is not under or over dosed. Insufficient addition of replenisher concentrate will produce incomplete development, whereas excessive replenisher will produce loss of image (etching).

### SUMMARY OF THE INVENTION

The present inventors have solved this problem in a simple, reliable and economical manner, by attacking the problem at the source. The invention eliminates (or greatly reduces) the carbon dioxide (CO₂) from the atmosphere in the processor. This is preferably achieved by passing a stream of air through a layer of alkaline material (such as sodium hydroxide, potassium hydroxide, etc.) which absorbs and neutralizes almost all of the carbon dioxide.

In one aspect, the invention is thus directed to a system and process for developing an imaged plate by contacting the plate with an alkaline developer, contained in a developer tank having a cover spaced over the developer level, wherein the improvement maintains the space between the developer level and cover, at a concentration of carbon dioxide below ambient for a substantial portion of each day.

Preferably, active carbon dioxide control is implemented in the space at least during idle periods, to maintain the concentration of carbon dioxide below about 100 ppm. In a system that is an idle state for at least eight hours per day, the concentration of carbon dioxide is preferably continuously maintained below about 10 ppm, throughout this idle state.

The method of prolonging the strength or life of the bath during idle periods, is preferably performed with a motorized air handling device to draw air out of the space, pass the drawn air through a carbon dioxide scavenger, and deliver the scavenged air back into the space. This stream of carbon dioxide free air blankets the developer prevents ambient room air from entering.

The system can be considered as comprising a first conduit having an extraction port in the space and a second conduit having a return port in the space. A contained volume of carbon dioxide scavenger material is fluidly connected between the first and second conduits. A motorized air handling device fluidly connected with the conduits and scavenger material, draws air out of the space through the extraction port, passes the drawn air through the carbon dioxide scavenger, and delivers the scavenged air back into the space through the return port.

Preferably, a dedicated seal or process cover closely fits over the perimeter of the surface of the bath, and defines a smaller space over the bath, with less air ambient air leakage, than the tank cover component of a typical purchased developer unit. Such dedicated cover is effective with or without use of a flat cover that floats on the surface of the bath.

The air handling circuit with CO₂ scavenger can be carried as a self-contained unit by the dedicated seal cover.

Because the absorption of carbon dioxide at the bath surface occurs constantly, the air handling circuit can advantageously be run continuously, during plate processing and during idle periods. As an alternative, a controller can be linked to a CO₂ meter, for intermittent operation of the air handling system to maintain the CO₂ concentration within a target band below a maximum.

### BRIEF DESCRIPTION OF THE DRAWINGS

FIG. 1 is a schematic representation of a developer system for lithographic printing plates, with a basic embodiment of the present invention;

FIG. 2 is a perspective view of the developer station of FIG. 1, showing a portion of the CO₂ removal system attached externally to the frame or housing of the developer;

FIG. 3 is a longitudinal section view of the developer of FIG. 1;

FIG. 4 is a schematic representation of a second embodiment of the present invention, in which a seal cover is provided over the bath, or bath with floating cover;

FIG. 5 is a perspective view of one version of the seal cover of the type shown in FIG. 4;

FIG. 6 is a graphic representation of the measured carbon dioxide concentration over a twenty-four hour idle period of the processor as represented in FIG. 1, with (or without) the scavenger line hocked and the pump running, but without any scavenger material in the canister;

FIG. 7 is a graphic representation of the carbon dioxide concentration over a twenty-four our idle period, for a set up as shown in FIG. 1, including scavenger material in the canister;

FIG. 8 is graphic representation of a test performed with the seal cover as depicted in FIGS. 4 and 5, but without the floating cover, showing that with a particular type of absorbent, the carbon dioxide concentration can drop from ambient to substantially zero, within fifteen minutes;

FIG. 9 is a graphic representation of a contest of a configuration similar to FIG. 8, showing the effect of adding NaOH pallets when the carbon dioxide concentration rises from substantially zero to 100 ppm;

FIG. 10 which extended the test of claim 9 to three-days, with a turning off and then a turning on of the scavenger system in the third day; and

FIG. 11 is a schematic representation of another embodiment, wherein the scavenging system is entirely mounted on the seal cover for the bath.

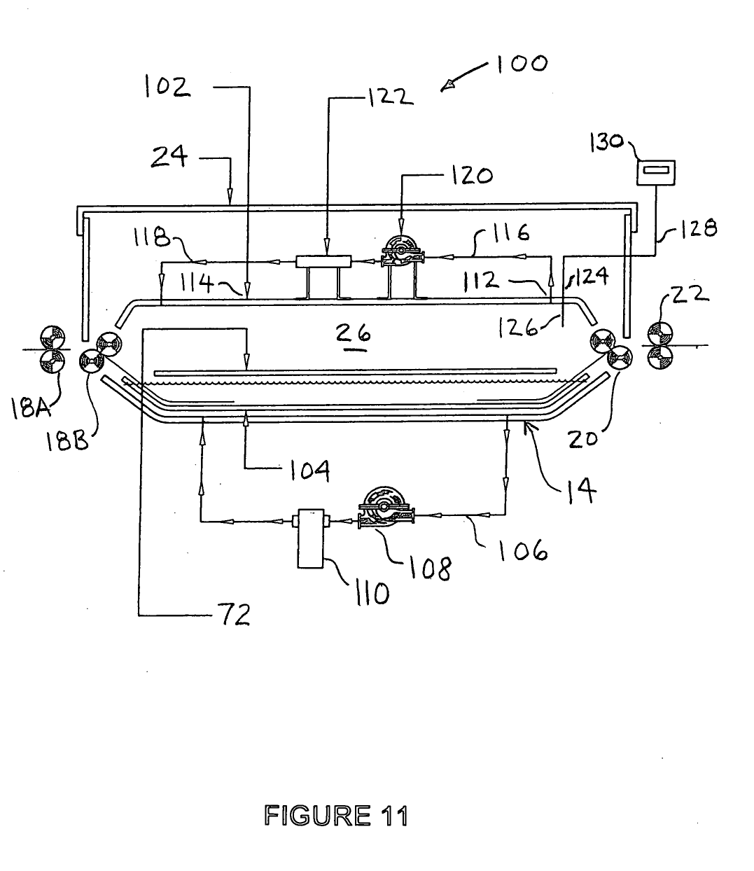

### DESCRIPTION OF THE PREFERRED EMBODIMENTS

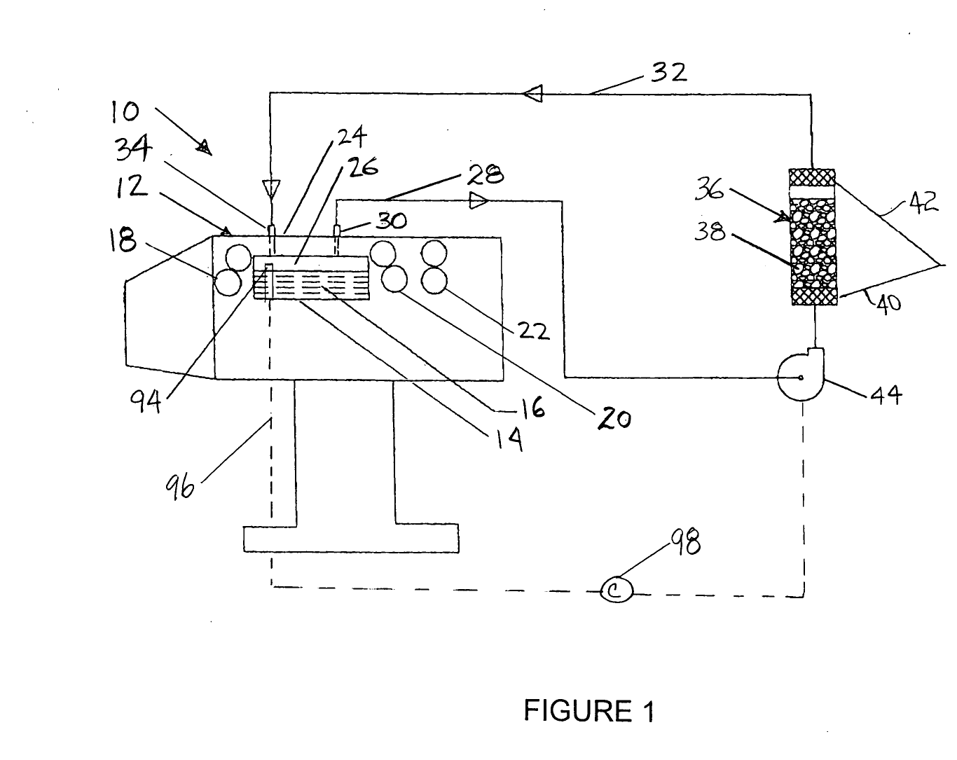

FIG. 1 shows a developer station or system 10, of a type for which the present invention is particularly well suited. The system comprises a frame or housing 12 in which is supported a developer tank 14 containing a developer solution, typically an alkaline developer such as is well known in this field of endeavor. A feed mechanism 18 advances an image-wise irradiated plate into the developer bath 16 and the associated transport mechanism 20 removes the plate from the bath for further processing (as will be described below), whereupon a discharge mechanism 22 discharges a developed plate from the station 10. The station includes a removable cover 24, by which the operator can selectively expose the tank for inspection or the like. A space 26 is thereby established between the bath 16 and the removable cover 24. As will be described below, other spaces may be formed between the liquid level and certain additional covers situated below the removable cover 24, but in the broadest aspect of the present invention, the space 26 can be considered as any substantially enclosed space formed between the bath and the removable cover.

In accordance with one aspect of the present invention, the space 26 is connected to a carbon dioxide removal or scavenging system, which maintains a very low concentration of carbon dioxide at the surface of the bath during idle periods, thereby greatly suppressing the reduction in developer effectiveness experienced in known developer systems. A rudimentary scavenging system is depicted in FIG. 1, wherein a first conduit 28 and associated extraction port 30 are in fluid communication with the space 26, for continually removing quantities of the gaseous material in the space 26 for CO₂ scavenging and then returning the “cleansed” air via conduit 32 and associated return port 34, back into the space 26. The gaseous material extracted via line 28 is passed through a canister or the like 36 defining a volume containing material that removes CO₂ from the extracted gas, such as sodium hydroxide pellets 38 or the like. The canister preferably has a mesh or screen at the inlet 40 and at the outlet 42 to retain fine particles of pellet material within the canister. The circulation loop is driven by an air handling device such as motor 44, which is preferably connected in the extraction conduit 28, between the extraction port 30 and the inlet 40 the canister 36.

In a relatively simple implementation of the present invention, during significant idle periods of the developer station 10, the motor 44 is run continuously, or intermittently with pre-established “on” and “off” time intervals. For example, a station operated only during one eight-hour work shift has a sixteen-hour idle period, whereas a workstation operated for two shifts would have an eight-hour idle period. Simply providing the scavenger recirculation system depicted in FIG. 1 to a typical developer station, such as a Proteck PCX 85 available from Proteck Circuits & Systems Ltd., Shollinganallur, Chennai, India, would reduce the average CO₂ concentration in the space 26, by at least about half if the pump is run continuously during an idle period of one or two work shifts.

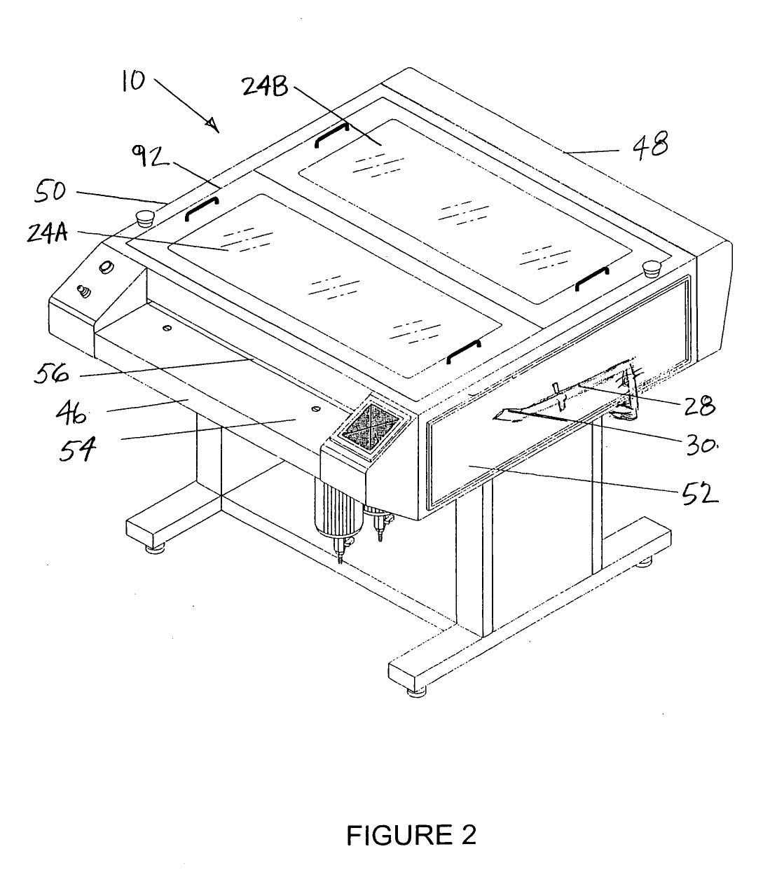

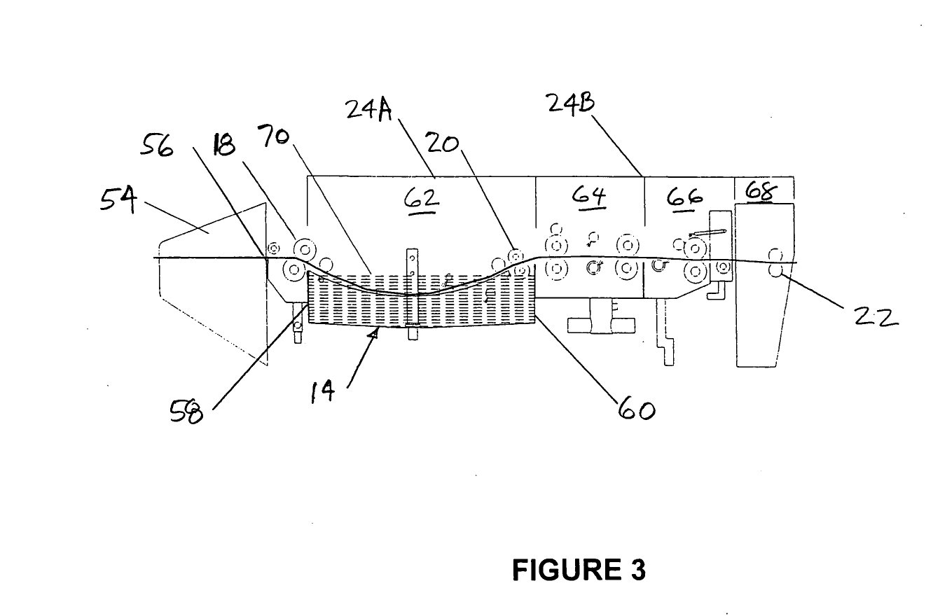

FIGS. 2 and 3 show further details of the developer station 10 of FIG. 1. The frame 12 has front, and back ends 46 and 48, and left and right sides 50, 52. A plate feed ramp 54 is situated at the front, with a feed slot 56 into which each plate is manually inserted. In one improvement according to the present invention, the feed slot is defined by a rubber flap or lip or the like, which permits insertion of the plate but, during idle periods, substantially seals the slot from in leaking of ambient air to the tank 14. The tank 14 has front and back ends 58, 60 (and left and right sides, not shown) which, with associated feed mechanism 18 and transport mechanism 20, are situated in the developer section 62 of the station. Wash section 64, gum section 66, and dryer section 68 follow the developer section, with associated processing and transport mechanisms that form no part of the present invention. In this embodiment, the discharge mechanism 22 is associated with the dryer section 68.

The plate enters the bath from above the front edge 58 of the tank 14, is conveyed downwardly in an arcuate path through the bath, then captured for removal by the transport mechanism 20, above the bath level 70. During idle periods, the bath level remains substantially as shown at 70 in FIG. 3, in relation to the tank 14 and transport mechanisms 18, 20 and removable cover 24a. Cover 24a is removably supported at its edges on a rim or the like in the frame, over the developer section 62, whereas cover 24b is likewise supported on along its edges, over the washer, gum, and dryer sections 64, 66, 68.

FIG. 2 shows the extraction port 30 entering the right side of the frame 52 and tank 14, with the associated conduit 28 secured by brackets to the frame, and leading beneath the wash section 64 of the station, to the associated scavenger and air handling devices represented in FIG. 1, with eventual penetration (not shown) of the return port to the other side 50 of the frame and tank. Whereas FIG. 1 shows the penetrations through the cover 24, FIG. 2 shows the penetrations through the sides 50, 52 of the frame. The particular locations and path for the penetrations and conduits are a matter of design choice, so long as the extraction and return ports 30, 34 are fluidly connected to the space 26 where a substantial volume of air can interact directly or indirectly with the surface of the developer bath.

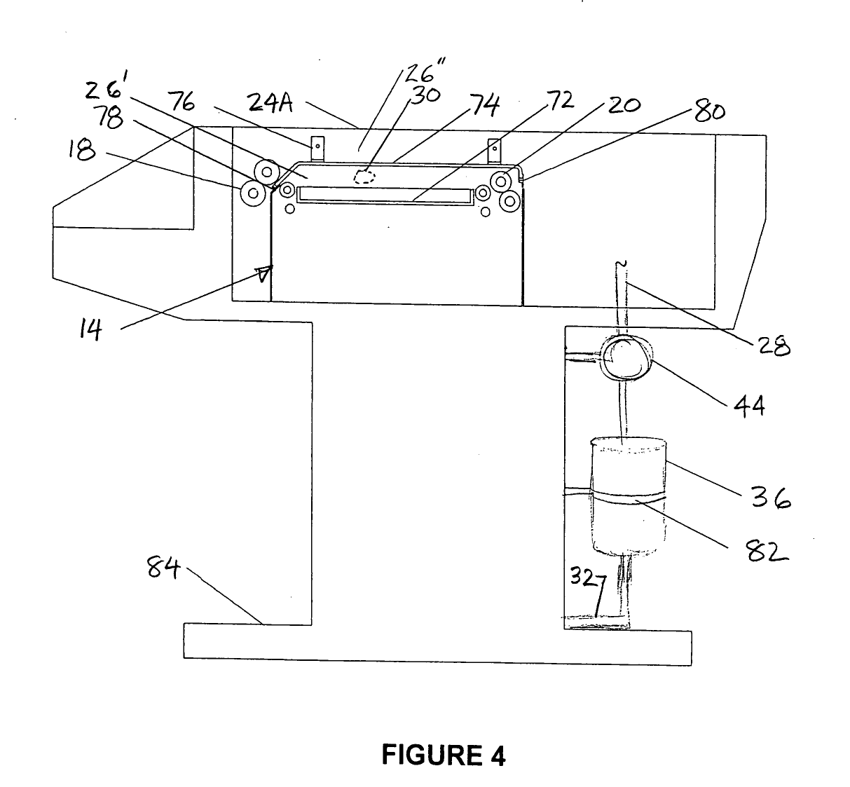

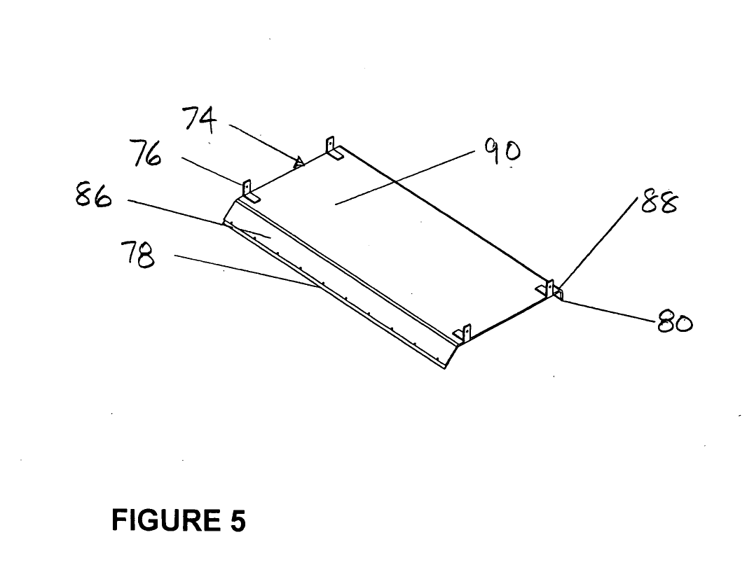

FIGS. 4 and 5 show a preferred embodiment for implementing the present invention. In a conventional developer station 10, it is known to provide a substantially flat anti-oxidation cover 72 that simply floats on the surface of the bath during idle periods. In the preferred embodiment, an additional seal cover 74 is provided, above the floating cover 72, supported by brackets 76 or the like on the left and right sides of the frame within space 26. The seal cover is attached, but can be removed for maintenance or the like. The seal cover 74 has a resilient front seal 78 that covers the front upper edge of the tank 14, and a resilient back seal 80 that covers or otherwise engages the back upper edge of the tank 14. This defines a smaller air space 26′, which is penetrated by the ports 30, 34 (only 30 is shown in phantom). The seal cover 74 can have a substantially flat top 90 with lateral edges that need not have resilient material, because the seal cover 74 can abut the side walls of the tank and thereby substantially completely cover the underlying developer at the sides of the tank. However, at the front and back of the tank, where the feed and transport mechanisms are located, coverage of the water level is incomplete, and accordingly, the resilient seals 78, 80 provide a substantial improvement in maintaining confinement of the air cover in space 26′.

The configuration shown in FIG. 4 can be considered as providing a bath cover 74 between the bath level and the tank cover 24, thereby forming a primary space 26′ between the bath level and the bath cover and a secondary space 26″ between the bath cover 74 and the tank cover 24. The system maintains the primary space 26′ at an acceptable concentration of carbon dioxide, ideally less than about 10 ppm. In general, a cover supported by the frame, over the tank, overlays a substantially closed space delineated by the bath liquid level, the cover, and the front end, back end, and sides of at least one of the frame or tank. Another cover such as floating cover 72 on or closely spaced from the liquid level, can alternatively define the lower portion of the space between the covers.

As shown in FIG. 5, the bath or seal cover 74 preferably has brackets 76 for engaging mating structures in the frame (either substantially permanent or selectively removable), and front 86 and back 88 angled portions that can enter into the regions associated with the feed and transport mechanisms 18, 20 where the plates enter and leave the tank, and which in conjunction with the resilient seals 78, 80, can substantially close off encroachment of ambient air through those leakage paths.

Also shown in FIG. 4 is one technique for mounting a recirculating scavenger system represented in FIG. 1 onto the frame 12. The portion of the extraction conduit 28 between extraction port 30 and the pump 44, has been omitted for clarity. Pump 44 and canister 36 are mounted to brackets 88 or the like. The CO₂-rich air removed via port 30 is pumped to canister 36, where the CO₂ is removed, and the cleansed stream is further delivered via return conduit 32, back to the other side of the tank where it penetrates the space 26′ via the return port 34 (not shown) which would generally be at the same elevation in the air space 26′ as the extraction port 30, although it is not required to be coaxial therewith. The extraction port could alternatively be located in a downstream section 64, 66, or 68. The pump and canister 36 could alternatively be connected at other locations on the frame, such as at the base 84 of the frame

As a further preference for minimizing the encroachment of ambient air into space 26′, the four edges 92 of the removable cover 24a shown in FIG. 2 likewise have resilient gaskets or the like.

With reference again to FIG. 1, another preferred aspect of the present invention will be described. A carbon dioxide sensor 94 is provided in the air space 26, and delivers a signal commensurate with the CO₂ level along signal line 96 to a controller 98, which in turn is operatively associated with the motor 44. Rather than running the motor during the entire idle period, or intermittently based on pre-established on and off periods, with this preferred embodiment, the motor is operated for air recirculation through the scavenging container, only when the measured level of carbon dioxide in space 26 exceeds a threshold value. For example, one can select an upper limit of 100 ppm in space 26, whereupon the motor will be started, and run until the carbon dioxide concentration reaches a minimum threshold level, typically below 10 ppm, whereupon the motor will be stopped. Inasmuch as typical ambient carbon dioxide concentration is on the order of 1000 ppm, and with the present invention the maximum permitted concentration during idle periods cab be held under about 100 ppm, the system maintains the carbon dioxide concentration throughout the idle period, lower than the ambient concentration by a factor of at least ten. Moreover, as will be shown below, with the regular replacement of the scavenger material in the canister 36, a continuous operation of the scavenger system can maintain the carbon dioxide concentration near one ppm.

An optimized control system of the type shown in FIG. 1 with CO₂ sensor and controller can cost-effectively maintain the CO₂ concentration at less than about 10 ppm for the entire idle period on one canister charge. One suitable control algorithm is for the pump to be started at regular intervals, such as every 5 to 20 minutes, for enabling the CO₂ meter to determine the concentration. If the concentration is above a maximum, such as 10 or 100 ppm, the pump continues to operate until the concentration drops below a target such as 1 or 10, respectively. If the scavenger circuit cannot drop the concentration below the target within a preset time period, such as 20 minutes, then a visible and/or audible signal is generated for prompting the operator to replace the cartridge.

One type of scavenger material suitable for use with the present invention, is a sodium hydroxide based absorbent available under the trademark DECARBITE from PW Perkins Co., Inc. of Woodstown, N.J. This particular material has a non-fibrous silicate to keep the particles from bonding in the presence of moisture that is formed as a byproduct of the absorption reaction.

Another suitable absorber is available under the SOFNOLIME trademark, as a soda lime absorbent formed by mixing calcium and sodium hydroxide, in the form of hard, porous, irregularly shaped granules. This is available from Molecular Products, Limited, Essex, U.K. The particle size is in the range of 8-12 mesh (1.0-2.5 mm) with an absorption capacity of more than 140 liters of carbon dioxide per kilogram of material.

A suitable carbon dioxide sensor is the Telaire 7000 series of indoor air quality monitors, available from the GE Industrial Sensing Division of the General Electric Company, headquartered in Billerica, Mass., U.S.A., which can measure carbon dioxide in the range of 0-10,000 ppm with a resolution of 1 ppm, having an accuracy of ±5 percent of the reading, with a maximum of plus or minus 50 ppm. Such sensors may requires a minimum of 1 mph air flow through the wand, which should be considered in the selection of the air handling motor for implementing the preferred embodiment.

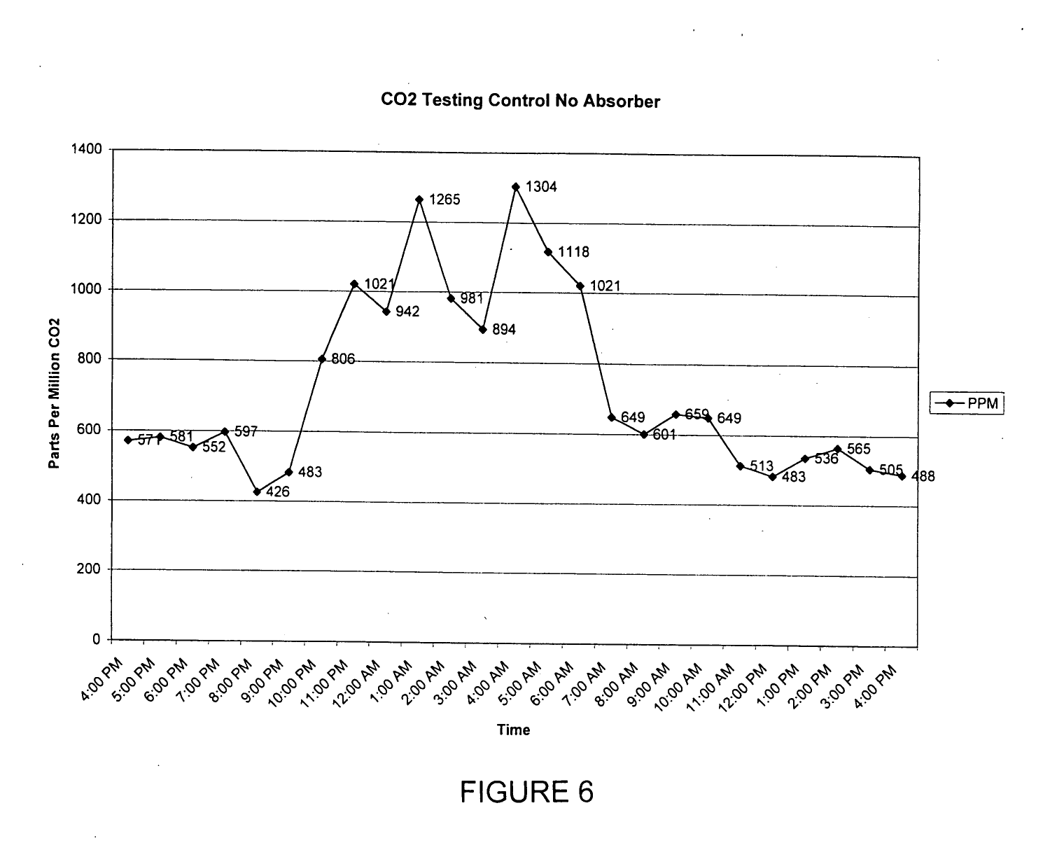

FIG. 6 is a schematic representation of another embodiment 100, wherein the scavenging components are mounted on the seal cover, or chemistry process cover, 102. As in the previous embodiments, the tank 14 has an inlet end at which, preferably, a set of first feed rollers 18a receives a plate in substantially horizontal orientation, for delivery to a second set of feed rollers 18b that redirect the plate downwardly along the guide plate 104 for submerging in the bath. Upon the emergence of the front edge of the plate, discharge rolls 20 grasp the plate and for removal from the bath and follower rolls 22 convey the plate horizontally for further processing. Preferably, although not necessary, the floating cover 72 rest on the surface of bath 16.

In a conventional manner, a developer flow line 106 including a chemistry pump and filter 108, 110, maintain the strength of the developer bath, especially during operation, when the plates themselves carry some developer solution with them out of the tank 14, and as the solution needs replenishment due to the chemical reactions associated with a development of the coating.

According to this embodiment of the invention, the seal cover 102 has on its top surface, an extraction port 112 and a return port 114, to which are fluidly connected an extraction line 116 and a return line 118, respectively. An air pump 122 and a canister 122 of CO₂ absorbing material are interpose between the extraction line. The continuous scavenging of the CO₂ in the confined space 26 above the bath 16, can be achieved with modest volumetric flow rates, for example, with a small air pump that handles a few cubic feet per minute, and a canister having a size of approximately 3 inches in diameter and 8 inches long. These can easily be mounted on the top surface of the cover as well. Accordingly, all of the CO₂ scavenging flow lines are carried on the cover 102. Also, the top of the cover includes a sensor port 124 through which a CO₂ sensor 126 is situated in the space 26, and sends a signal through associated data line 128, to the CO₂ monitor 130. Preferably, the monitor is supported externally of the processors, so the data line 128 penetrates a wall of the processor between the processor cover 24 and the seal cover 102.

One of only rudimentary skill in process control, could readily connect a manual switch to the air pump 120, either on the seal cover 102 if, for example, the pump is to be turned on for continuous scavenging flow over a uninterrupted period of time. Similarly, such person could readily connect a controller between the CO₂ monitor 130 or the associated data line 128, and a logic device associated with air pump 120, to turn the pump on when the measured ppm is above a maximum threshold such as 100 ppm, and to turn the pump off when the measured ppm is below a minimum, such as 10 ppm.

The inventors performed a variety of tests to confirm the effectiveness of the inventive concept, using the Proteck PCX85 equipment depicted in FIGS. 1-4. The developer solution was Anocoil T-8 thermal positive plate developer, available from Anocoil Corporation of Rockville, Conn. The throughput speed was 5 feet per minute, and the temperature was maintained at 70 deg. F.

For Test I, a floating cover was put in place to protect the developer but no replenishment system was set up. Once the developer had reached the operating temperature an Anocoil 830-22 positive thermal plate imaged with a multi screen test image was processed. Along with the test plate a sample of the developer was taken to document its alkalinity through titration. All of the screen values on the plate were read with an ICI Dot Meter and the Background and Image were read with an X-Rite calorimeter. As a final test, a portion of both the image and the background were rubbed with black newspaper style ink. These areas were then rinsed with cold water and rubbed gently with a clean cotton cloth. The plate was then dried and the ink densities of both areas were read with the X-Rite colorimeter. These same tests were repeated every 24 hours until the process yielded an unacceptable plate. Once this portion of the test was complete the processor was drained, cleaned and charged with fresh T-8 developer.

For Test II, the floating cover was installed without the use of any replenishment system. However, this time the processor was fitted with the filter/scrubber system that removes carbon dioxide from the air. The air stream entered the front left corner of the developer section and exited on the back right side in the gum section. As a result the air was constantly being recirculated through the alkaline filter/scrubber. The same test as before was repeated until an unacceptable plate was produced. A comparison of the test results is shown below.

### Test I: Control Test Without Carbon Dioxide Absorber

The condition of Table I represents the idle condition with floating anti-oxidation cover 72 as sold by the supplier of the Proteck equipment, without any operational carbon dioxide scavenger equipment connected to the space 26 between the floating cover 72 and the removable cover 24. Furthermore, no lip seal was provided at the feed slot 50, and no gasket seal was provided around the edges 92 of the removable cover 24. The pump was turned off for the entire test and the developer replenishment rate was set to 7 cc's per square foot of plate passed through the bath. Any excess loss of developer through evaporation was measured every day and replaced with deionized water.

| | | |
|---|---|---|
| | Dry Ink Test | Titration Results |
| Plate Readings | (clean, slight, moderate, or heavy) | (Average of 3) |

Day 1

| | | | |
|---|---|---|---|
| L | 73.48 | | |
| a | −.53 | | |
| b | −.66 | Clean | 11.9 |

Day 2

| | | | |
|---|---|---|---|
| L | 72.49 | | |
| a | −.69 | | |
| b | −.55 | Moderate | 11.9 |

Day 3

| | | | |
|---|---|---|---|
| L | 73.08 | | |
| a | −.79 | | |
| b | −.64 | Moderate/Heavy | 12.1 |

Day 4

| | | | |
|---|---|---|---|
| L | 71.73 | | |
| a | −1.01 | | |
| b | −.59 | Heavy | 11.9 |

Based on the dry ink results the test was stopped after day 4, the developer drained and the processor set up for Test II.

### Test II: With the Carbon Dioxide Absorber Unit

The processor was filled with T-8 solution and set to 70 degrees Fahrenheit. The pump was off initially and the developer replenishment rate was set to 7 cc's per square foot. Any excess loss of developer through evaporation was measured every day and replaced with deionized water. The canister contained 500 grams of Sofnolime scavenger material and the air flow rate was pumped at 0.5 cfm. The pump was then turned on and run for six days with the following results:

| | | |
|---|---|---|
| | Dry Ink Test | Titration Results |
| Plate Readings | (clean, slight, moderate, heavy) | (Average of 3) |

Day 1

| | | | |
|---|---|---|---|
| L | 72.25 | | |
| a | −.45 | | |
| b | −.49 | Clean | 12.0 |

(No plates run
Days 2–3)

Day 4

| | | | |
|---|---|---|---|
| L | 72.00 | | |
| a | −.60 | | |
| b | −.60 | Clean | 12.0 |

Day 5

| | | | |
|---|---|---|---|
| L | 73.27 | | |
| a | −.84 | | |
| b | −.58 | Moderate | 12.1 |

Day 6

| | | | |
|---|---|---|---|
| L | 72.12 | | |
| a | −.87 | | |
| b | −.60 | Moderate/Heavy | 12.0 |

The L, a, and b values indicate standard color measurements of developed lithographic printing plates suitable for newspaper production. The “a” reading is most significant, with a value of −0.50 to −0.65 being most acceptable for Anocoil plates. It can be seen that in Test I by the second day the “a” value has exceeded the acceptance value and has deteriorated rapidly thereafter. In Test II the carbon dioxide scavenging system was operated substantially as shown in FIG. 1, with the air space still defined between the floating cover 72 and the removable cover 24. The data in the table show that the “a” value remained in a commercially acceptable range for at least four days, which is twice as long as the condition of Table I. The ultimate test for acceptability is the dry ink test, whereas the pH value is of only peripheral interest.

### Test III: With the Carbon Dioxide Absorber and Intermediate Cover

In Test III, the CO₂ removal system was operated continuously, without the floating cover in place, with an intermediate or bath cover as shown in FIG. 1. The “a” value remained in the acceptable range for seven days and the developed plates would appear to remain clean indefinitely so long as the pump was operated and the scavenger material does not deplete.

| | | |
|---|---|---|
| | Dry Ink Test | Titration Results |
| Plate Readings | (clean, slight, moderate, heavy) | (Average of 3) |

Day 1

| | | | |
|---|---|---|---|
| L | 72.75 | | |
| a | −.50 | | |
| b | −.55 | Clean | 11.95 |

Day 2

| | | | |
|---|---|---|---|
| L | 72.78 | | |
| a | −.49 | | |
| b | −.58 | Clean | 11.95 |

Day 3

| | | | |
|---|---|---|---|
| L | 73.59 | | |
| a | −.57 | | |
| b | −.55 | Clean | 11.95 |

(No plates run
Days 4–5)

Day 6

| | | | |
|---|---|---|---|
| L | 73.38 | | |
| a | −.57 | | |
| b | −.55 | Clean | 12.0 |

Day 7

| | | | |
|---|---|---|---|
| L | 73.54 | | |
| a | −.59 | | |
| b | −.58 | Moderate | 12.0 |

A second phase of testing was then undertaken. Prior to running the test the room was monitored overnight for levels of carbon dioxide and recorded without the absorber device running. On average the room was measured at 900 ppm. Then the absorber unit was installed with the inlet and exhaust on the front section of the processor and operated overnight with the CO₂ measured. The absorber did make an impact on the levels, with the range being 250 ppm to 680 ppm. In an effort to lower the levels and to also minimize the fluctuations, the entry of the processor was sealed with plastic with a fine slit made to allow plates to be processed and a curtain was installed on the exit of the developer section to minimize the air flow out of the processor, in a manner shown in FIG. 4. This was monitored overnight and the readings ranged from 40 ppm to 50 ppm. Tests were then conducted to learn: (1) How long the developer will stay active without the replenishment of the scavenger material, (2) how the strength of the sodium hydroxide in the developer weakens over time, and (3) the effectiveness of the seal cover on the tank over time.

Plates were run for six days with the background reading of the plate ranging from −0.54 to −0.60 on day six. The strength of the developer ranged from a titration of 12 on day 1 to 11.94 on day six. This is a good indication that the sodium hydroxide is not being depleted due to excess carbon dioxide levels in the open tank. The levels of CO₂ averaged 60 ppm over the six day period. When multiple plates were run at a time, the CO₂ would rise to 225 ppm and then drop to 40 ppm within 10 minutes. The background of the plate dry inked clean every day. The only replenishment added to the processor was to compensate for the drag out of the developer from the plates. This was also the case with any earlier testing. The test was stopped at this point.

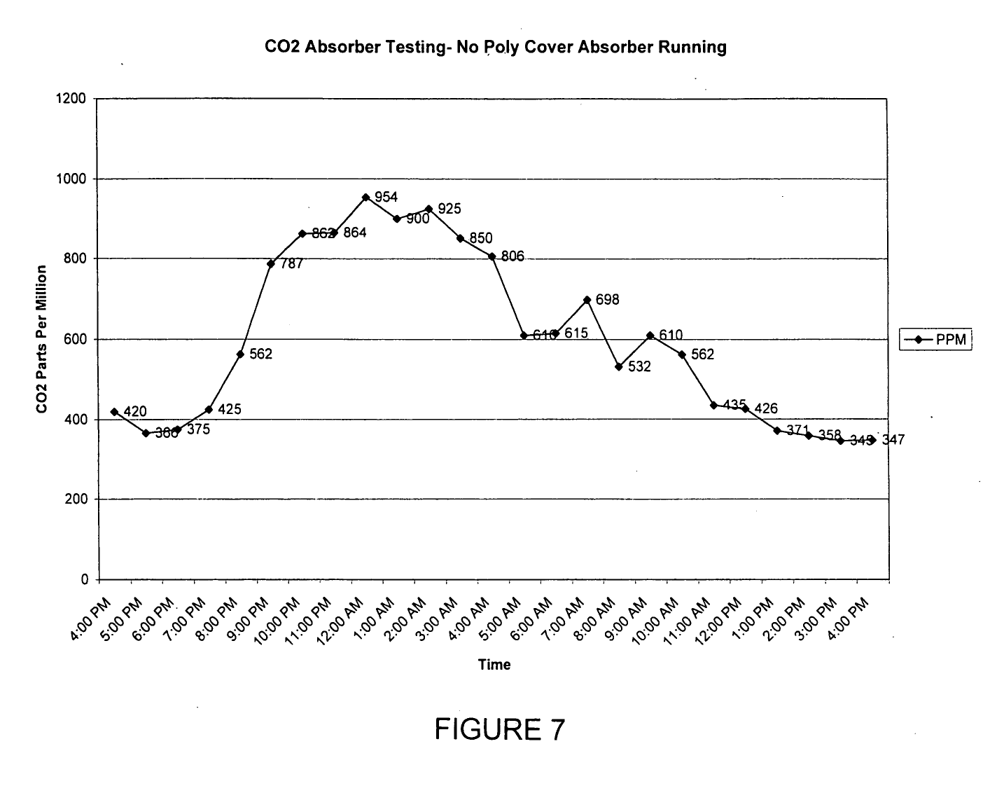

FIG. 6 shows the measurement of carbon dioxide during a 24 hour period within the time period of the Test I. Although the concentration varies, the concentration remains well above 500 ppm, and ranges up to 1,300 ppm, for substantially the entire 24 hour period. A similar 24 hour test period is shown in FIG. 7 with respect to Test II, where the concentration varies during the 24 hour period, but is substantially less than that shown with respect to the data from Test I.

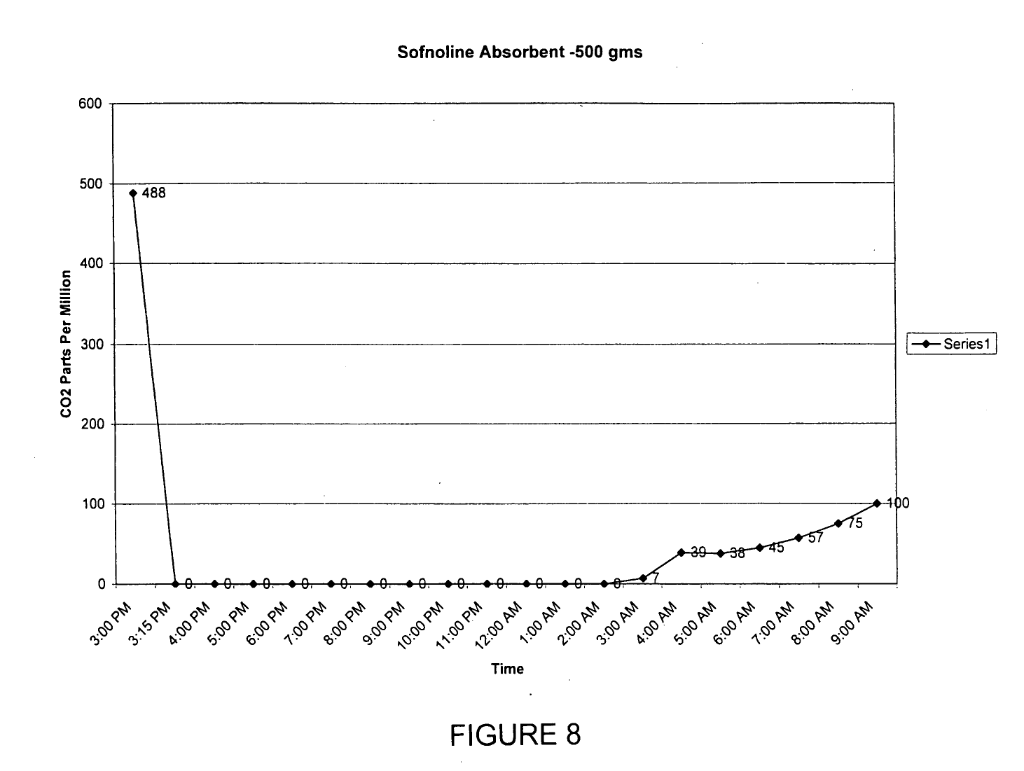

FIG. 8 shows that for the configuration of Test III from an initial concentration of 488 ppm, the recirculation with carbon dioxide scavenging reduces the concentration to substantially zero, within about 15 minutes. The level remains at substantially zero for about 12 hours, whereupon it slowly increases to about 100 ppm over the course of about 6 hours. This test was performed with the Sofnolime absorbent.

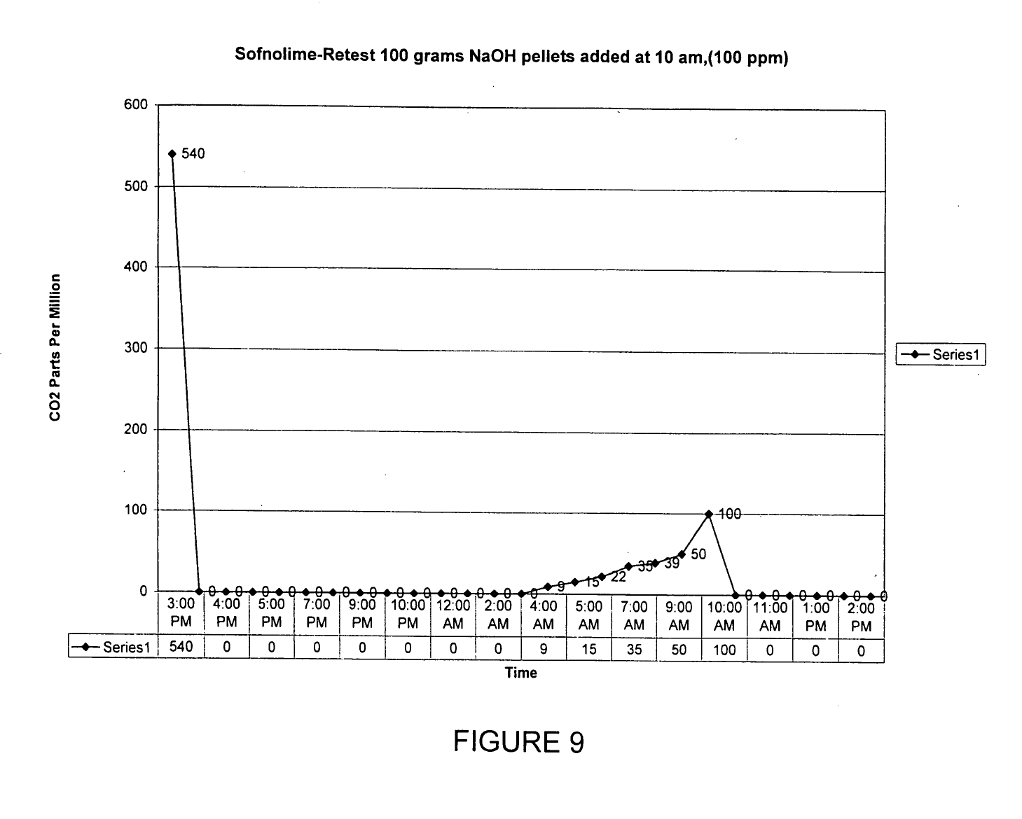

FIG. 9 shows results that are substantially identical to those of FIG. 8, except that 100 grams of sodium hydroxide pellets were added to the 500 grams of Sofnolime when the CO₂ concentration reached 100 ppm. The CO₂ concentration returned to substantially zero within five minutes.

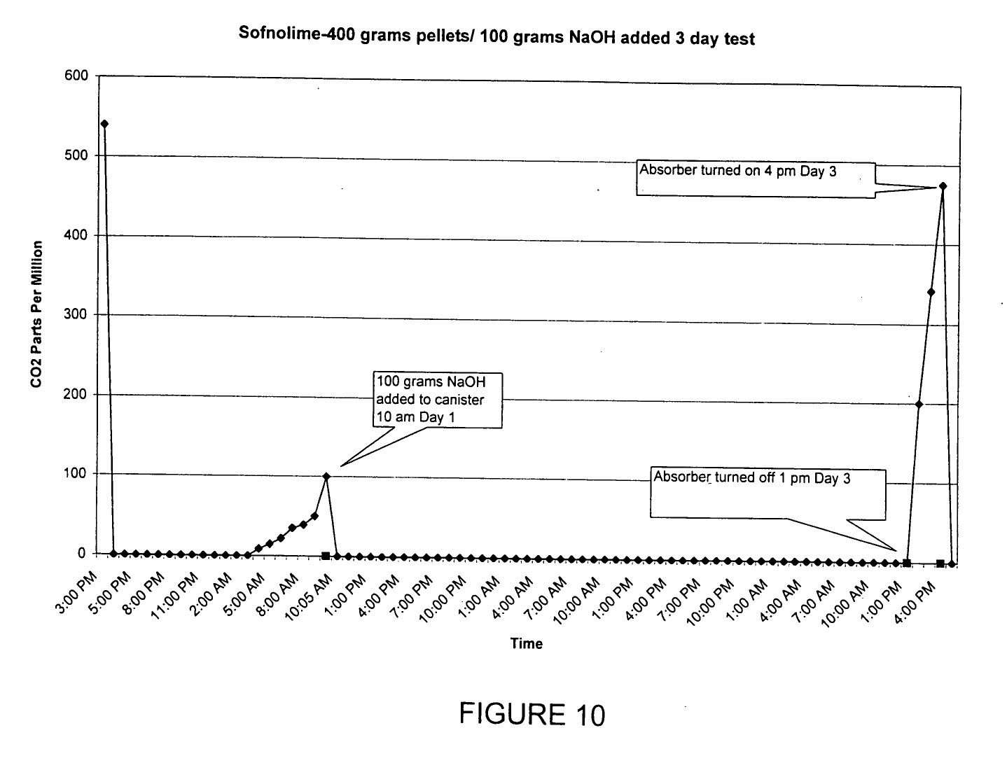

FIG. 10 shows another test with the canister containing 400 grams of Sofnolime pellets and 100 grams of sodium hydroxide added during a three-day test. It can be seen that, substantially as previously shown, the concentration drops on the first day to zero within about 15 minutes, and remains there, until it begins to increase. When it reaches 100 ppm the sodium hydroxide is added and the concentration remains at zero again for a substantial period of time. When the circulating system is turned off at 1:00 p.m. at Day 3, the concentration rises quickly to 500 ppm within about two hours, whereupon turning on the system again quickly reduces the concentration back to zero.

The foregoing data suggest that any arbitrarily low concentration of carbon dioxide can be maintained, so long as the absorber material is replenished. The concentration can be maintained below a very effective maximum threshold, for example 100 ppm, or even 10 ppm, if the pump is intermittently operated based on the measurement and control system described above with respect to FIG. 1. In particular, it can be appreciated that the concentration can be reduced to substantially zero, within about 15 minutes, but it takes two or more hours for the concentration to rise to 100 ppm. This suggests that an intermittent operation of 15 minutes on and about two hours off can maintain the concentration below 100 ppm.

In a preferred method of operation, the maximum concentration is maintained below 10 ppm, by operating the pump intermittently based on measured CO₂ concentration. The test data indicate that this can be achieved with the pump on for about one tenth of the idle period, e.g., running about two minutes every 20 minutes of idle time. In the present context, operating the pump “continually” includes continuously, intermittently on a preset schedule, and nonuniformly under a control scheme that depends on a measured variable. As a practical guide for conditions in which the scavenging system is not continuously extracting, scavenging, and returning air flow, at each instance when the air flow through the scavenger device is initiated, the scavenging should continue until the CO₂ concentration in the space above the bath is reduced by a factor of at least about ten.

### Test IV: Long Term with Carbon Dioxide Absorber, and Special Bath Cover.

Test IV shows that the CO₂ concentration can be maintained well below 10 ppm, at essentially 0 ppm, for at least one week in a commercial developer, before the need for a canister change.

| | | |
|---|---|---|
| | Dry Ink Test) | Titration Results |
| Plate Readings | (clean, slight, moderate, Heavy) | (Average of 3) |

Day 1

| | | | |
|---|---|---|---|
| L | 72.59 | Clean | 11.97 |
| a | −.55 | | |
| b | −.63 | | |

Day 4

| | | | |
|---|---|---|---|
| L | 72.09 | | |
| a | −.52 | | |
| b | −.55 | Clean | 11.99 |

Day 5

| | | | |
|---|---|---|---|
| L | 72.66 | | |
| a | −.61 | | |
| b | −.65 | Clean | 11.95 |

Day 6

| | | | |
|---|---|---|---|
| L | 72.13 | | |
| a | −.64 | | |
| b | −.64 | Clean | 11.97 |

Day 7

| | | | |
|---|---|---|---|
| L | 72.44 | | |
| a | −.65 | | |
| b | −.61 | Clean | 12.0 |

Day 8 (100 mls. of developer added due to low tank level).

| | | | |
|---|---|---|---|
| L | 72.58 | | |
| a | −.62 | | |
| b | −.64 | Clean | 11.97 |

Day 11

| | | | |
|---|---|---|---|
| L | 72.77 | | |
| a | −.66 | | |
| b | −.60 | Clean | 11.99 |

| | |
|---|---|
| CO₂ readings PPM | |
| Day 1 2:30 pm | 1352 parts per million |
| 2:35 pm | 0 parts per million |
| Day 2 | 0 parts per million |
| Day 3 | 0 parts per million |
| Day 4 | 0 parts per million |
| Day 5 | 0 parts per million |
| Day 6 | 0 Parts per million |
| Day 7 | 0 Parts per million |
| Day 8 | 0 Parts per million |
| Day 9 | 0 Parts per million |
| Day 10, (2:30 am) | 5 Parts per million |
| Day 10, (9 am) | 9 Parts per million |
| Day 10, (12 pm) | 15 Parts per million |
| Day 10, (9 pm) | 17 Parts per million |
| Day 11, (4 am) | 35 Parts per million |
| Day 11, (9 am) | 45 Parts per million, (Testing stopped) |

Day 11 at 9:15 am the pump was turned off and within 2 hours the C0₂
levels were at 930 Parts Per Million.

The test was performed over an eleven-day period, with the scavenging system operating continuously. Test IV shows that the “a” value associated with a plate run through the developer on each day, was at a commercially good value. Similarly, the pH remains substantially the same, at approximately 12.0 throughout the eleven-day period. Most importantly, from the initial condition of ambient CO₂ at 1352 ppm at 2:30 pm on Day 1, the scavenging system reduced the CO₂ concentration to zero parts per million by 2:35 pm that day and maintained zero parts per million through Day 9. During the subsequent two days, the concentration gradually rises to 45 ppm, whereupon the testing was stopped at 9 a.m. on Day 11. When the pump was turned off at 9:15 am on Day 11, the CO₂ concentration increased over the ensuring two hours, up to 930 ppm.

It can be appreciated that the scavenging material could have lasted much longer if the system were controlled, in a manner analogous to a thermostat, such that the pump would cycle intermittently to maintain the CO₂ concentration within a band of, for example zero to 5 or zero to 10 ppm.

Test IV was performed using the Proteck PSC 85 developing station with the bath cover shown in FIG. 5. The tank was filled with 15-gallons of T-8 developer solution set to 70 degrees Fahrenheit. The airflow was controlled by an Apollo pump rated a 2-cubic feet per minute. The canister contained 500 grams of absorber material, half of which was Sofnolime and half of which was NaOH. Although the test was intended to model a prolonged idle period of the processor, the condition of the developer was periodically tested not only by measuring the pH, but also developing a plate. Each plate slightly diminished the strength of the developing solution, as a result of both the chemical reaction associated with developing the image, and the drag through or carry-over of a small quantity of a developer solution physically present on the plate as it emerges from developing tank. These were compensated in the usual manner, according to procedures well known in the industry.

1. In a system for developing an imaged plate by contacting the plate with an alkaline developer, contained in a developer tank having a cover spaced over the developer level, a method of prolonging the life of the developer comprising: maintaining the space between the developer level and the cover, at a concentration of carbon dioxide below ambient for a substantial portion of each day.

2. The method of claim 1, comprising maintaining the carbon dioxide concentration in said space at least during idle periods below about 100 ppm.

3. The method of claim 1, wherein the system is in an idle state for at least 8 hours per day and the concentration of carbon dioxide is continuously maintained below about 100 ppm throughout said idle state.

4. The method of claim 1, wherein the concentration of carbon dioxide is continuously maintained below about 100 ppm by continually drawing air out of said space, passing the drawn air through a carbon dioxide scavenger, and delivering the scavenged air back into said space.

5. The method of claim 4, wherein the concentration of carbon dioxide is continuously maintained below about 10 ppm by passing said drawn air through a canister of scavenger pellets.

6. The method of claim 1, wherein the system includes a first, cover over the developer and a second cover between the developer level and the first cover, thereby forming a primary space between the developer level and the second cover and a secondary space between the second cover and the first cover, and the method includes maintaining the primary space at a concentration of carbon dioxide less than about 10 ppm.

7. The method of claim 6, wherein the concentration of carbon dioxide is continuously maintained below about 10 ppm in said primary space by continually drawing air out of said primary space, passing the drawn air through a carbon dioxide scavenger, and delivering the scavenged air back into said primary space.

8. The method of claim 1, including another, substantially flat cover that floats on and substantially entirely covers the developer level, and wherein said space is established between the flat cover and said cover spaced over the developer level and maintained at a concentration of carbon dioxide less than about 100 ppm.

9. The method of claim 8, wherein the concentration of carbon dioxide is continuously maintained below about 100 ppm in said-space by continually drawing air out of said space, passing the drawn air through a carbon dioxide scavenger, and delivering the scavenged air back into said space.

10. The method of claim 1, wherein
one cover floats on said developer level and another cover is interposed between the floating cover and said cover spaced over the developer level;
said space is established between the floating cover and said other cover; and
said space is maintained at a carbon dioxide concentration of less than about 100 ppm.

11. In a system for developing an imaged plate by transporting the plate through an alkaline developer, contained in a developer tank having a tank cover spaced over the developer level, a method of prolonging the life of the developer, comprising:
operating an air handling device to draw air out of said space, pass the drawn air through a carbon dioxide scavenger, and deliver the scavenged air back into said space.

12. The method of claim 11, including
continually measuring the carbon dioxide concentration in said space; and
in response to said measured concentration reaching a maximum permitted threshold, operating the air handling device to reduce the carbon dioxide concentration by a factor of at least about ten below said maximum permitted threshold.

13. The method of claim 12, wherein
the concentration of carbon dioxide is reduced by passing said drawn air through a canister of scavenger pellets; and
the maximum permitted concentration threshold, the air flow rate of the air handling device, and the mass of pellets in said canister are selected such that when the system is in an idle state, the air handling system operates intermittently for a total of less than about one hour every eight hours.

14. The method of claim 13, wherein the pellets comprise sodium hydroxide pellets.

15. A system for developing an imaged plate, comprising:
a frame having front and back ends and opposed sides;
a tank supported in the frame, having front and back ends and opposed sides, containing a liquid alkaline developer defining a liquid level;
a feed mechanism at the front of the tank for receiving imaged plates in series and conveying the plates into the developer;
transport means for conveying the plates in the tank through the developer;
a cover overlying a substantially closed space delineated by the developer liquid level, said cover, and the front end, back end, and sides of at least one of the frame or tank;
a first conduit having an extraction port in said space;
a second conduit having a return port in said space;
a contained volume of carbon dioxide scavenger material fluidly connected between said first and second conduits; and
a motorized air handling device fluidly connected with the conduits and scavenger material, to draw air out of said space through said extraction port, pass the drawn air through said carbon dioxide scavenger, and deliver the scavenged air back into said space through said return port.

16. The system of claim 15, wherein the carbon dioxide scavenger material is in the form of pellets in a canister and the canister, conduits, and air handling device are mounted to the frame.

17. The system of claim 15, wherein the carbon dioxide scavenger material is in the form of pellets in a canister and the canister, conduits, and air handling device are mounted to said cover.

18. The system of claim 15, including another cover spaced from the liquid level, thereby defining said space as between the other cover and the liquid level, wherein the carbon dioxide concentration in the space is maintained below about 100 ppm.

19. The system of claim 18, wherein the carbon dioxide scavenger material is in the form of pellets in a canister and the canister, conduits, and air handling device are mounted to said other cover.

20. The system of claim 18, wherein a slot opens at the front of the frame for passing a plate into the feed mechanism, and a seal is provided around the slot for closely contacting the plates as the plates are passed to the feed mechanism.

21. The system of claim 20, wherein the other cover has edges that seat on the frame and at least one of the edges or seat has a resilient seal.

22. The system of claim 15, including a carbon dioxide concentration sensor in said space, and a controller responsive to the sensor, for turning the air handling device on when the carbon dioxide concentration is above a predetermined maximum threshold and turning the air handling device off when the concentration is below another, predetermined minimum threshold.

23. The system of claim 22, wherein the maximum threshold is below 100 ppm and the minimum threshold is below 10 ppm.

24. The system of claim 23, wherein the maximum threshold is about 10 ppm.

25. The system of claim 15, wherein
said cover is a top cover over the tank;
a second cover floats on said developer and a third cover is interposed between the floating cover and the top cover;
said space is established between the floating cover and said third cover; and
said space is maintained at a carbon dioxide concentration of less than about 100 ppm.

26. The system of claim 25, wherein said third cover has resilient front and back ends for closely conforming to the front and back ends of the tank.

27. The system of claim 25, wherein the carbon dioxide scavenger material is in the form of pellets in a canister and the canister, conduits, and air handling device are mounted to said third cover.
